(19) United States
(12) Patent Application Publication
(10) Pub. No.: US 2026/0175749 A1
(43) Pub. Date: Jun. 25, 2026

(54) RECLINING DEVICE AND VEHICLE SEAT

(71) Applicants: NHK SPRING CO., LTD., Yokohama-shi (JP); SUBARU CORPORATION, Tokyo (JP)

(72) Inventors: Hiroshi YAGAME, Yokohama-shi (JP); Yuhei TSUKUTA, Yokohama-shi (JP); Masaya SHODA, Yokohama-shi (JP); Noriyuki FUKUCHI, Yokohama-shi (JP); Fumito KITANAKA, Tokyo (JP); Masato FUKUSHIMA, Tokyo (JP); Ayaka KASHIWAGI, Tokyo (JP)

(21) Appl. No.: 19/421,596

(22) Filed: Dec. 16, 2025

(30) Foreign Application Priority Data
Dec. 20, 2024 (JP) 2024-225724

(51) Int. Cl. B60N 2/22

(52) U.S. Cl. CPC B60N 2/2218

(57) ABSTRACT

In a reclining device, a lock mechanism locks tilting of a seat back. A knob is connected to a connecting cylinder, and in a case in which the knob is operated, the connecting cylinder is rotated, and a lock mechanism unlocks tilting of the seat back. At a time of a side collision of a vehicle, an impact load is input to the knob, and the knob is disconnected from the connecting cylinder. Therefore, even in a case in which the knob is operated by an impact load, the rotation of the connecting cylinder can be suppressed, and the unlocking of the tilting of the seat back can be suppressed.

### CROSS-REFERENCE TO RELATED APPLICATION

This application is based on and claims priority under 35 USC 119 from Japanese Patent Application No. 2024-225724 filed on Dec. 20, 2024, the disclosure of which is incorporated by reference herein.

### BACKGROUND

### Technical Field

The present invention relates to a reclining device in which a lock mechanism locks tilting of a seat back, and a vehicle seat provided with the reclining device.

### Related Art

In a seat described in Japanese Patent Application Laid-Open (JP-A) No. 2000-108738, tilting of a seat back is locked, and a reclining lever is operated to unlock the tilting of the seat back.

In this seat, at the time of side collision of a vehicle, the operation of the reclining lever due to input of an impact load to the reclining lever is suppressed by a bracket for preventing upward shift of the lever, and unlocking of the tilting of the seat back is suppressed.

### SUMMARY

In view of the above fact, an object of the invention is to provide a reclining device and a vehicle seat which can suppress unlocking of tilting of a seat back at the time of side collision of a vehicle.

A reclining device of a first aspect of the invention includes: a lock mechanism locking tilting of a seat back in a vehicle seat; a connecting member connected to the lock mechanism, the connecting member being rotated so that the lock mechanism unlocks tilting of the seat back; and an operation member connected to the connecting member, the operation member being operated to rotate the connecting member and being disconnected from the connecting member by receiving an impact load at a time of a side collision of a vehicle.

In the reclining device of the first aspect of the invention, the lock mechanism locks tilting of the seat back in the vehicle seat. The connecting member is connected to the lock mechanism, the operation member is connected to the connecting member, and the operation member is operated to rotate the connecting member, so that the lock mechanism unlocks tilting of the seat back.

At the time of a side collision of the vehicle, an impact load is input to the operation member, and the operation member is disconnected from the connecting member. Therefore, even in a case in which the operation member is operated by an impact load, the rotation of the connecting member can be suppressed, and the unlocking of the tilting of the seat back can be suppressed.

In a reclining device of a second aspect of the invention in the reclining device of the first aspect of the invention, the connecting member is disposed inside an outer periphery of the operation member.

In the reclining device of the second aspect of the invention, the connecting member is disposed inside the outer periphery of the operation member. Therefore, an impact load can be input to the operation member before the connecting member.

A reclining device of a third aspect of the invention in the reclining device of the first or second aspect of the invention includes a locking portion locking detachment of the operation member.

In the reclining device of the third aspect of the invention, the locking portion locks detachment of the operation member. Therefore, even in a case in which the operation member is disconnected from the connecting member, detachment of the operation member can be restricted.

In a reclining device of a fourth aspect of the invention in the reclining device of any one of the first to third aspects of the invention, the operation member is connected to the connecting member by a biasing force after the operation member has been disconnected from the connecting member.

In the reclining device of the fourth aspect of the invention, the operation member is connected to the connecting member by a biasing force after the operation member has been disconnected from the connecting member. Therefore, tilting of the seat back can be unlocked by the operation of the operation member.

In a reclining device of a fifth aspect of the invention in the reclining device of any one of the first to the third aspects of the invention, the connecting member is operated to be rotatable after the operation member has been disconnected from the connecting member.

In the reclining device of the fifth aspect of the invention, the connecting member is operated to be rotatable after the operation member has been disconnected from the connecting member. Therefore, tilting of the seat back can be unlocked by the operation of the connecting member.

A vehicle seat of a sixth aspect of the invention includes: a seat cushion; a seat back; and the reclining device of any one of the first to fifth aspects provided between the seat cushion and the seat back.

In the vehicle seat of the sixth aspect of the invention, the reclining device of any one of the first to fifth aspects of the invention is provided between the seat cushion and the seat back. Therefore, the same effects as those of any one of the first to fifth aspects of the invention can be obtained.

### BRIEF DESCRIPTION OF THE DRAWINGS

Exemplary embodiments of the present invention will be described in detail based on the following figures, wherein:

FIG. 1 is an exploded perspective view illustrating a vehicle seat according to a first embodiment of the invention as viewed from a diagonally front left side;

FIG. 2 is a side view illustrating the vehicle seat according to the first embodiment of the invention as viewed from a left side;

FIG. 3A is a perspective view illustrating a main part of the vehicle seat according to the first embodiment of the invention as viewed from a diagonally front right side;

FIG. 3B is a perspective view illustrating a connecting cylinder of the vehicle seat according to the first embodiment of the invention as viewed from a diagonally front left side;

FIG. 4A is a cross-sectional view (a cross-sectional view taken along line 4A-4A in FIG. 2) of the main part of the vehicle seat according to the first embodiment of the invention as viewed from a front side;

FIG. 4B is a cross-sectional view (a cross-sectional view taken along line 4B-4B in FIG. 2) of the main part of the vehicle seat according to the first embodiment of the invention as viewed from an upper side;

FIG. 5A is a schematic cross-sectional view illustrating a normal state of the main part of the vehicle seat according to the first embodiment of the invention as viewed from a front side;

FIG. 5B is a schematic cross-sectional view illustrating a state at the time of side collision of a vehicle in the main part of the vehicle seat according to the first embodiment of the invention as viewed from a front side;

FIG. 5C is a schematic cross-sectional view illustrating a state after the side collision of a vehicle in the main part of the vehicle seat according to the first embodiment of the invention as viewed from a front side;

FIG. 6A is a perspective view illustrating a state at the time of side collision of a vehicle in the connecting cylinder and a knob of the vehicle seat according to the first embodiment of the invention as viewed from a left side;

FIG. 6B is a perspective view illustrating a first stage after the side collision of a vehicle in the connecting cylinder and the knob of the vehicle seat according to the first embodiment of the invention as viewed from a left side;

FIG. 6C is a perspective view illustrating a second stage after the side collision of a vehicle in the connecting cylinder and the knob of the vehicle seat according to the first embodiment of the invention as viewed from a left side;

FIG. 7A is a front view illustrating the connecting cylinder and the knob of the vehicle seat according to the first embodiment of the invention as viewed from a left side;

FIG. 7B is a top view illustrating a state at the time of side collision of a vehicle in the connecting cylinder and a knob of the vehicle seat according to the first embodiment of the invention as viewed from an upper side;

FIG. 8 is an exploded perspective view illustrating a vehicle seat according to a second embodiment of the invention as viewed from a diagonally front left side;

FIG. 9A is a side view illustrating the vehicle seat according to the second embodiment of the invention as viewed from a left side;

FIG. 9B is a front view illustrating the connecting cylinder and the knob of the vehicle seat according to the second embodiment of the invention as viewed from a left side;

FIG. 10A is a perspective view illustrating a main part of the vehicle seat according to the second embodiment of the invention as viewed from a diagonally front right side;

FIG. 10B is a perspective view illustrating a connecting cylinder of the vehicle seat according to the second embodiment of the invention as viewed from a left side;

FIG. 11A is a cross-sectional view (a cross-sectional view taken along line 11A-11A in FIG. 9A) of the main part of the vehicle seat according to the second embodiment of the invention as viewed from a front side;

FIG. 11B is a cross-sectional view (a cross-sectional view taken along line 11B-11B in FIG. 9A) of the main part of the vehicle seat according to the second embodiment of the invention as viewed from an upper side;

FIG. 12A is a perspective view illustrating a state after the side collision of a vehicle in the main part of the vehicle seat according to the second embodiment of the invention as viewed from a diagonally front left side; and

FIG. 12B is a perspective view illustrating a state at the time of rotational operation of a cap after the side collision of a vehicle of the main part of the vehicle seat according to the second embodiment of the invention as viewed from a diagonally front left side.

### DETAILED DESCRIPTION

### First Embodiment

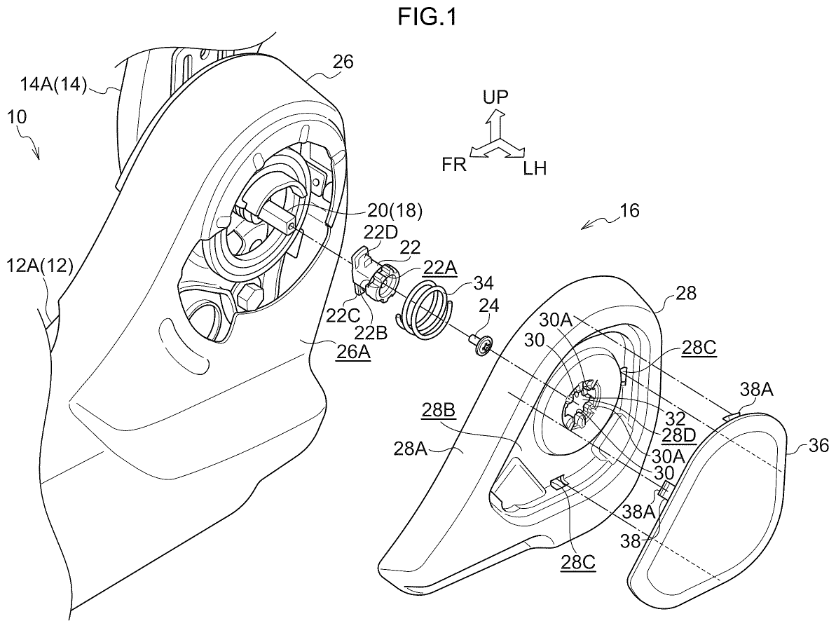

FIG. 1 is an exploded perspective view illustrating a vehicle seat 10 according to a first embodiment of the invention as viewed from a diagonally front left side. In the drawings, the front side of the vehicle seat 10 is indicated by an arrow FR, the left side (outside in a vehicle width direction) of the vehicle seat 10 is indicated by an arrow LH, and the upper side of the vehicle seat 10 is indicated by an arrow UP.

The vehicle seat 10 according to this embodiment is provided on the front side and the left side of a vehicle interior of a vehicle (automobile), and a B-pillar of the vehicle is disposed near the left side of a rear end portion of the vehicle seat 10. A seat cushion 12 is provided below the vehicle seat 10, and an occupant of the vehicle is seated on the seat cushion 12. A seat back 14 is provided on the upper side of a rear end portion of the seat cushion 12, and the seat back 14 supports the back of the occupant.

As illustrated in FIG. 1, a reclining device 16 is provided between a cushion hinge 12A of the seat cushion 12 and a back hinge 14A of the seat back 14.

A lock mechanism 18 is provided in the reclining device 16, and the lock mechanism 18 locks tilting of the seat back 14 (back hinge 14A). The lock mechanism 18 is provided with a shaft 20 having a substantially columnar shape and made of a metal as a release portion, and the shaft 20 extends leftward and has a distal end portion (left end portion) formed in a substantially rectangular columnar shape.

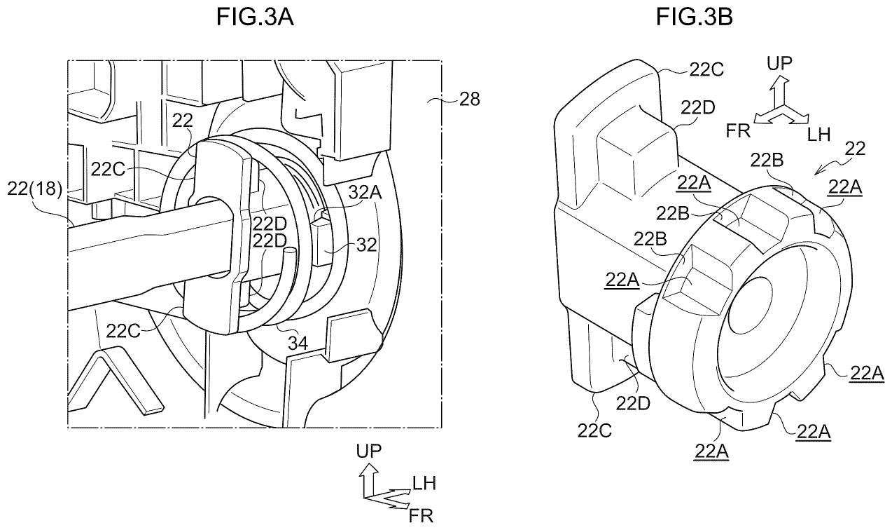

A connecting cylinder 22 (see FIG. 3B) having a substantially bottomed rectangular tubular shape and made of a resin as a connecting member is disposed at a distal end portion of the shaft 20. The inside of the connecting cylinder 22 is opened to the right side, and the distal end portion of the shaft 20 is fitted to the inside of the connecting cylinder 22 so as to be integrally rotatable with the shaft 20. A screw 24 penetrates a bottom wall (left wall) of the connecting cylinder 22, and the screw 24 is screwed to the distal end portion of the shaft 20 to fix the connecting cylinder 22 to the distal end portion of the shaft 20.

A left end portion of the connecting cylinder 22 is enlarged in diameter to have a substantially cylindrical shape. A plurality (six in this embodiment) of connecting recesses 22A having a substantially trapezoidal columnar shape as connected portions are formed at the left end portion of the connecting cylinder 22, and the connecting recesses 22A are disposed at intervals on the upper portion and the lower portion of the connecting cylinder 22. The connecting recess 22A extends in the right-left direction (the axial direction of the connecting cylinder 22), and the connecting recess 22A is opened to the radially outer side and the left side of the connecting cylinder 22. A receiving wall 22B having a substantially trapezoidal plate shape as a crushed portion is integrally provided at a right end of the connecting recess 22A, and the receiving wall 22B closes the right side of the connecting recess 22A. A bottom surface of the connecting recess 22A is flush with the outer peripheral surface on the right side of the receiving wall 22B of the connecting cylinder 22.

A receiving plate 22C having a rectangular plate shape is integrally provided at an upper end portion and a lower end portion of a right end of the connecting cylinder 22, and the receiving plate 22C protrudes radially outward of the connecting cylinder 22. The connecting cylinder 22 is integrally provided with a receiving column 22D having a substantially rectangular columnar shape on the left side of the receiving plate 22C, and the receiving column 22D protrudes radially outward of the connecting cylinder 22 and is integrally formed with the receiving plate 22C.

A cover 26 made of a resin as an arrangement member is provided on the left side of the lock mechanism 18, and the cover 26 covers a portion from a rear portion of the seat cushion 12 to a lower end portion of the seat back 14 from the left side. An arrangement recess 26A having a substantially trapezoidal shape in front view is formed in a rear portion of the cover 26, and the arrangement recess 26A is opened to the left side, the upper side, the front side, and the rear side. The shaft 20 of the lock mechanism 18 penetrates the bottom wall (right wall) of the arrangement recess 26A, and the distal end portion of the shaft 20 and the connecting cylinder 22 are disposed in the arrangement recess 26A.

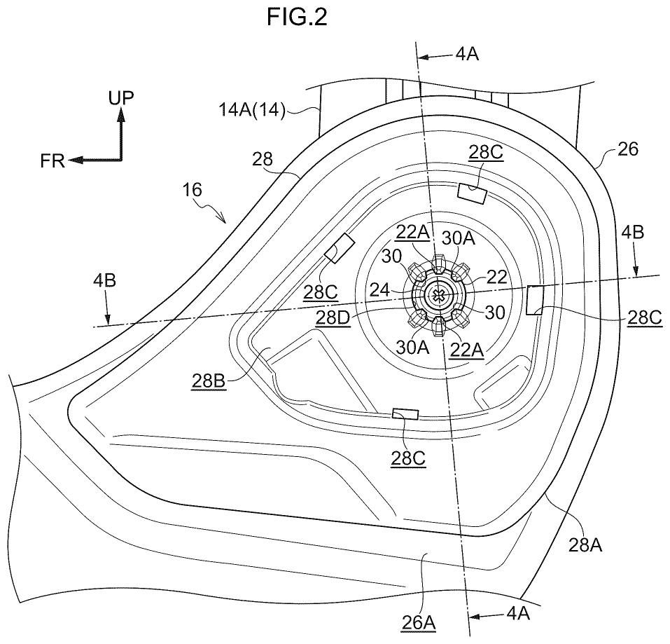

In the arrangement recess 26A, a knob 28 (see FIG. 2) having a substantially trapezoidal plate shape and made of a resin as an operation member is disposed, and a front portion of the knob 28 protrudes forward. A tubular peripheral wall 28A is integrally provided on the entire circumference of the knob 28, and the peripheral wall 28A protrudes rightward. A coupling recess 28B having a substantially trapezoidal shape in front view is formed in the knob 28, and the coupling recess 28B is opened to the left side and has a front portion protruding forward. A rectangular coupling hole 28C as a coupled portion is formed to penetrate through an upper portion, a lower portion, a front portion, and a rear portion of a peripheral portion of the coupling recess 28B.

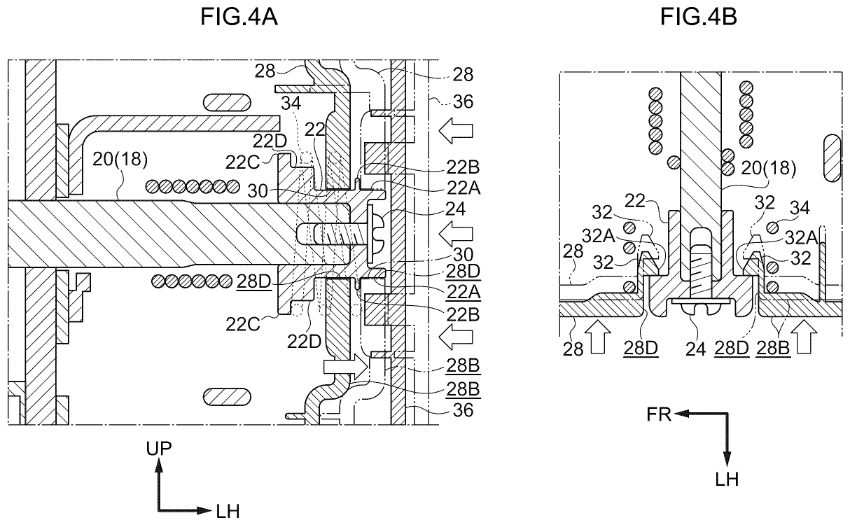

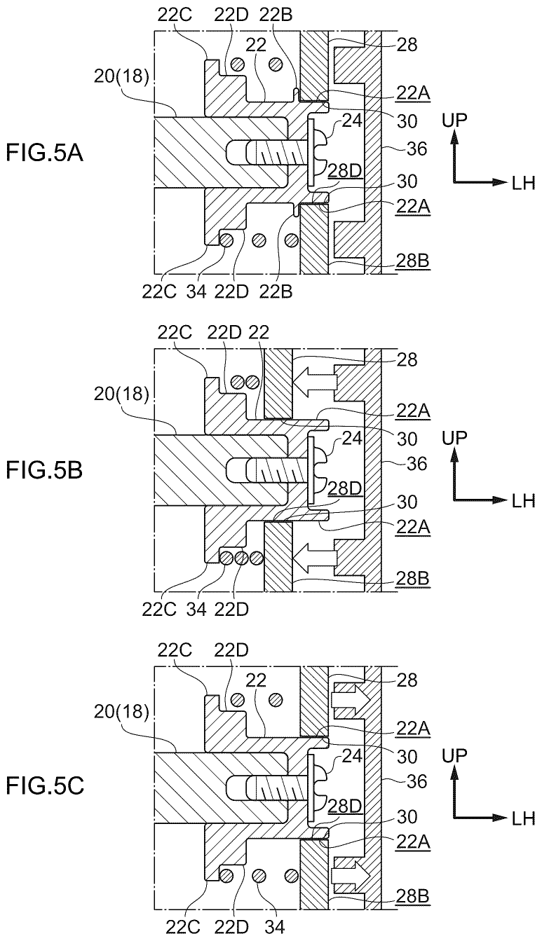

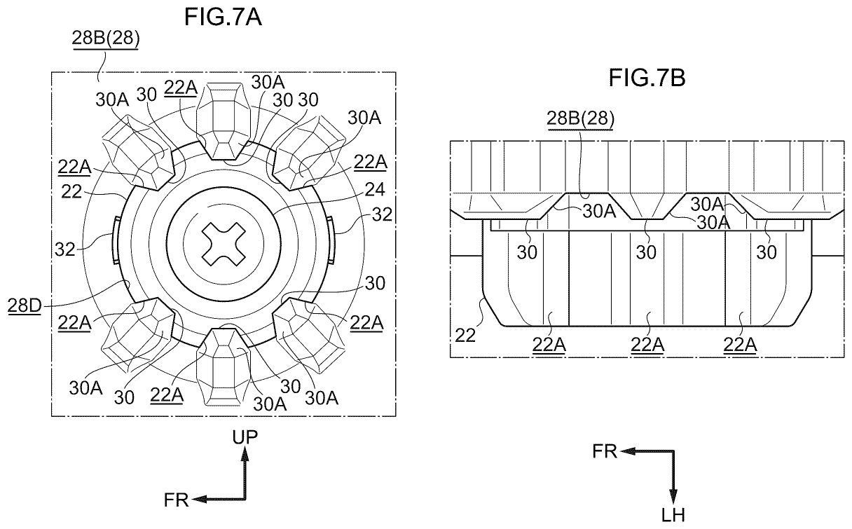

A connecting hole 28D (see FIG. 7A) having a substantially circular shape is formed to penetrate through a central portion of a bottom wall (right wall) of the coupling recess 28B, and the left end portion of the connecting cylinder 22 is fitted into the connecting hole 28D. A plurality (six in this embodiment) of connecting projections 30 having a substantially trapezoidal columnar shape as connecting portions are integrally provided on the peripheral surface of the connecting hole 28D, and the connecting projections 30 are disposed at intervals on the upper side and the lower side of the connecting hole 28D. The connecting projection 30 extends in the right-left direction (the axial direction of the connecting hole 28D), and the peripheral portion of the left surface of the connecting projection 30 on the connecting hole 28D side is an inclined surface 30A and is inclined in the direction toward the right side as it goes toward the connecting hole 28D (see FIG. 7B). The connecting projection 30 is fitted into the connecting recess 22A of the connecting cylinder 22, the knob 28 is operated to rotate the front portion upward by the occupant, and the connecting cylinder 22 is rotated integrally with the knob 28, so that the shaft 20 of the lock mechanism 18 is rotated integrally with the connecting cylinder 22, and the lock mechanism 18 unlocks the tilting of the seat back 14. The connecting projection 30 abuts on the receiving wall 22B of the connecting cylinder 22, whereby the rightward movement of the knob 28 is restricted (see a two-dot chain line in FIG. 4A and FIG. 5A).

A locking claw 32 (see FIG. 4B) having a substantially rectangular plate shape as a locking portion is integrally provided on the right side of the bottom wall of the coupling recess 28B on the front side and the rear side of the connecting hole 28D, and the locking claw 32 extends rightward. A locking protrusion 32A having a triangular prism shape is integrally provided at a distal end portion (right end portion) of the locking claw 32, and the locking protrusion 32A protrudes to the connecting hole 28D side and has a left surface disposed perpendicular to the right-left direction. The locking claw 32 locks the locking protrusion 32A to the left end portion of the connecting cylinder 22 from the right side by temporary elastic deformation, whereby the leftward movement of the locking protrusion 32A is locked and the leftward movement of the knob 28 is locked.

The connecting cylinder 22 is inserted into a coil spring 34 as a biasing member, and the receiving column 22D of the connecting cylinder 22 restricts the movement of the coil spring 34 in the radial direction. The coil spring 34 spans between the receiving plate 22C of the connecting cylinder 22 and the bottom wall of the coupling recess 28B and is compressed, and the coil spring 34 biases the knob 28 to the left side.

A cap 36 (see a two-dot chain line in FIG. 4A and FIG. 5A) having a substantially trapezoidal plate shape and made of a resin as a covering member is fitted to the coupling recess 28B, and a front portion of the cap 36 protrudes forward. The movement of the peripheral portion of the cap 36 into the coupling recess 28B is locked, and the left surface of the cap 36 is flush with the left surface of the knob 28. A coupling claw 38 having a substantially rectangular plate shape as a coupling portion is integrally provided at an upper portion, a lower portion, a front portion, and a rear portion of the peripheral portion of the cap 36, and the coupling claw 38 extends rightward. A coupling protrusion 38A having a triangular prism shape is integrally provided at a distal end portion (right end portion) of the coupling claw 38, and the coupling protrusion 38A protrudes to the outside of the coupling recess 28B and has a left surface disposed perpendicular to the right-left direction. The coupling claw 38 is inserted into the coupling hole 28C on a bottom wall of the coupling recess 28B by temporary elastic deformation, and the coupling protrusion 38A is locked from the right side to the periphery of the coupling hole 28C on the bottom wall of the coupling recess 28B, so that the leftward movement of the coupling protrusion 38A is locked, and the leftward movement of the cap 36 is locked, whereby the cap 36 is integrally rotatably connected to the knob 28.

Next, the operation of this embodiment will be described.

In the reclining device 16 of the vehicle seat 10 having the above configuration, the lock mechanism 18 locks the tilting of the seat back 14, and the connecting cylinder 22 is integrally rotatably connected to the shaft 20 of the lock mechanism 18. The connecting projection 30 of the knob 28 is fitted into the connecting recess 22A of the connecting cylinder 22, and the knob 28 is integrally rotatably connected to the connecting cylinder 22. In a case in which the knob 28 (including the cap 36) is operated to rotate the front portion upward, the connecting cylinder 22 and the shaft 20 are rotated integrally with the knob 28, and the lock mechanism 18 unlocks the tilting of the seat back 14.

In a case in which an impact load from the B-pillar of the vehicle is input to the knob 28 at the time of side collision of the vehicle and the knob 28 is moved rightward (inward in the vehicle width direction) so that the connecting projection 30 crushes the receiving wall 22B of the connecting cylinder 22 and the fitting of the connecting projection 30 to the connecting recess 22A is released, the knob 28 is disconnected from the connecting cylinder 22 (see a solid line in FIG. 4A and FIGS. 5B and 6A). Therefore, even in a case in which the knob 28 is operated to rotate by an impact load, the rotation of the connecting cylinder 22 can be suppressed, so that the unlocking of the tilting of the seat back 14 can be suppressed and the unnecessary tilting of the seat back 14 can be suppressed.

The left surface of the knob 28 is flush with the left surface of the cap 36, and the left surface of the connecting cylinder 22 is disposed on the right side (inner side) of the left surface (outer periphery) of the knob 28 (see FIG. 5A). Therefore, at the time of side collision of the vehicle, an impact load can be input to the knob 28 before the connecting cylinder 22, and the knob 28 can be appropriately disconnected from the connecting cylinder 22.

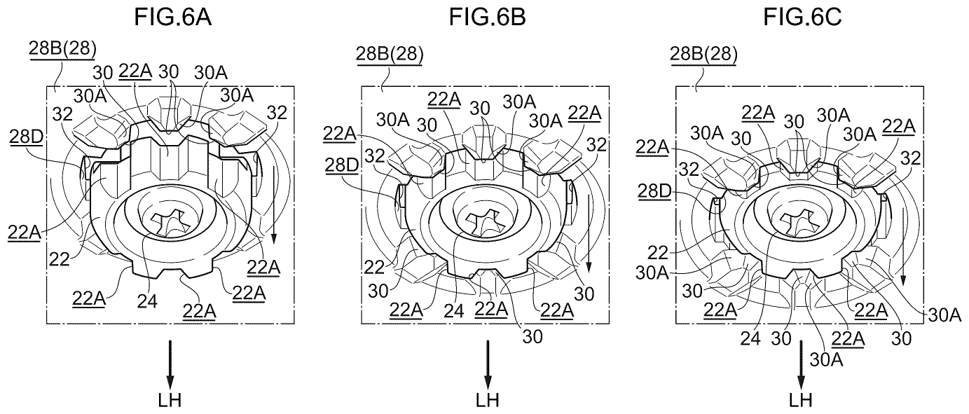

After the side collision of the vehicle (after the knob 28 is disconnected from the connecting cylinder 22), the knob 28 is moved leftward by the biasing force of the coil spring 34, so that the connecting projection 30 is fitted into the connecting recess 22A, and the knob 28 is connected to the connecting cylinder 22 (see FIGS. 5C, 6B, and 6C). Therefore, the tilting of the seat back 14 can be unlocked by the rotational operation of the knob 28, the seat back 14 can be tilted, and the occupant can escape to the outside of the vehicle, for example.

In a case in which the knob 28 is moved leftward by the biasing force of the coil spring 34 after the side collision of the vehicle, the connecting projection 30 is guided to the connecting recess 22A by the inclined surface 30A of the connecting projection 30 (see FIG. 7B). Therefore, the connecting projection 30 can be easily fitted into the connecting recess 22A, and the knob 28 can be easily connected to the connecting cylinder 22.

In a case in which the locking protrusion 32A of the locking claw 32 of the knob 28 is locked to the left end portion of the connecting cylinder 22, the leftward movement of the knob 28 is locked and the detachment of the knob 28 from the connecting cylinder 22 is locked (see FIG. 4B). Therefore, even in a case in which the fitting of the connecting projection 30 to the connecting recess 22A is released and the knob 28 is disconnected from the connecting cylinder 22 at the time of side collision of the vehicle, the locking protrusion 32A of the locking claw 32 is locked to the left end portion of the connecting cylinder 22, so that the detachment of the knob 28 from the connecting cylinder 22 can be restricted.

In this embodiment, the inclined surface 30A is provided in the connecting projection 30, and the connecting projection 30 is guided to the connecting recess 22A by the inclined surface 30A after the side collision of the vehicle. However, an inclined surface may be provided on the peripheral surface of the connecting recess 22A, and the connecting projection 30 may be guided to the connecting recess 22A by the inclined surface after the side collision of the vehicle.

In this embodiment, the knob 28 is operated to rotate after the side collision of the vehicle, whereby the tilting of the seat back 14 is unlocked. However, the cap 36 is detached from the knob 28 and the connecting cylinder 22 is operated to rotate after the side collision of the vehicle, whereby the tilting of the seat back 14 may be unlocked.

### Second Embodiment

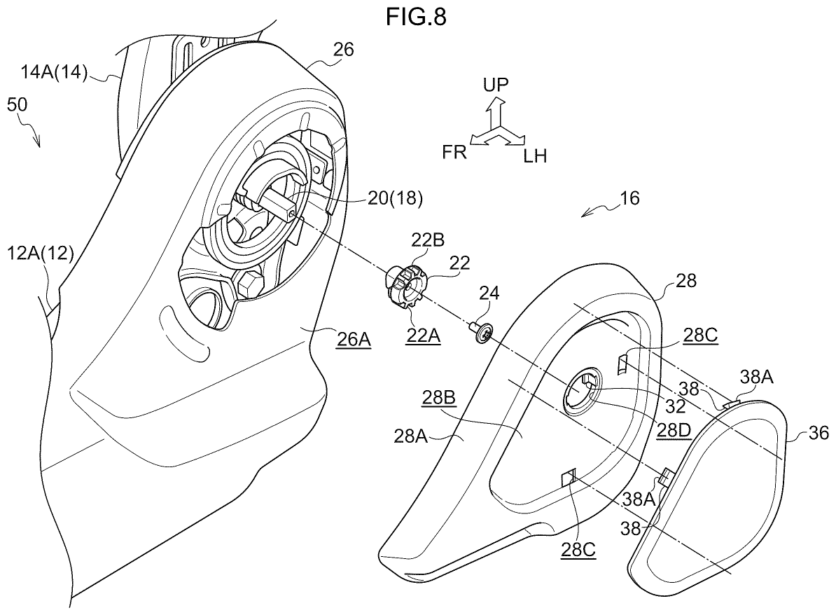

FIG. 8 is an exploded perspective view illustrating a vehicle seat 50 according to a second embodiment of the invention as viewed from a diagonally front left side.

The vehicle seat 50 according to this embodiment has substantially the same configuration as that of the first embodiment, but differs in the following points.

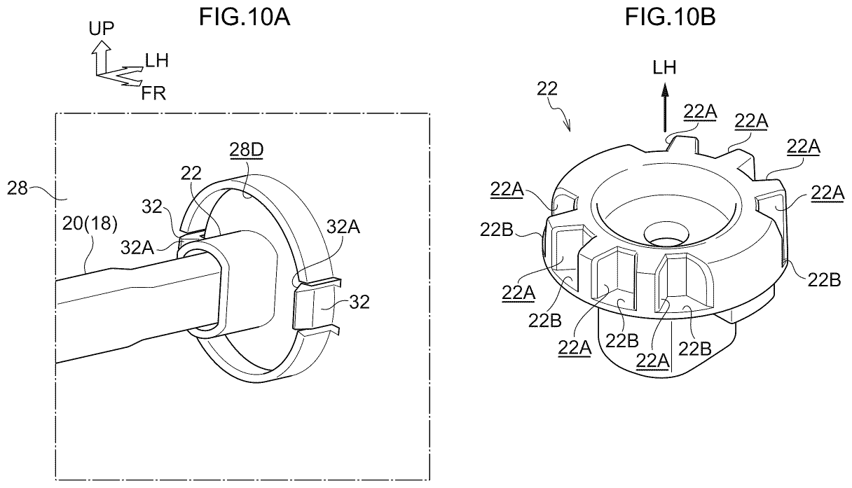

As illustrated in FIG. 8, in the reclining device 16 of the vehicle seat 50, the connecting cylinder 22 is not provided with the receiving plate 22C and the receiving column 22D (see FIG. 10B), and the coil spring 34 is not provided.

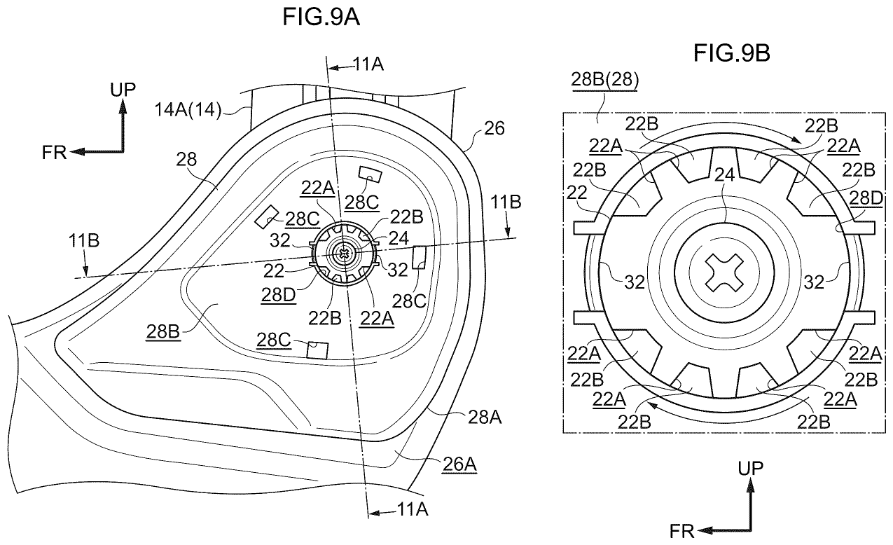

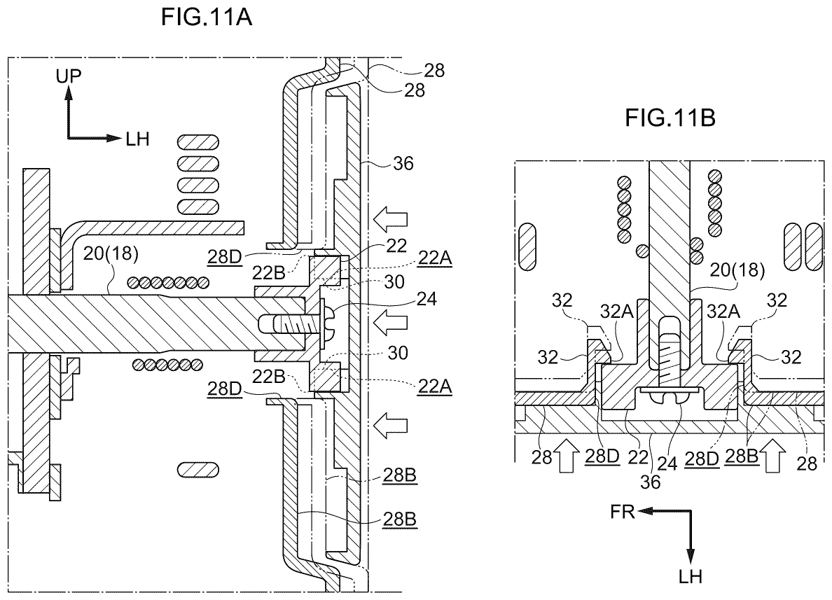

The connecting projection 30 is not provided on the peripheral surface of the connecting hole 28D of the knob 28 (see FIGS. 9A and 9B), and a plurality (eight in this embodiment) of connecting projections 30 are integrally provided on the right surface of the cap 36 as a connecting member (see FIG. 11A). The plurality of connecting projections 30 are respectively fitted and fixed to the plurality (eight in this embodiment) of connecting recesses 22A of the connecting cylinder 22, and the cap 36 is undetachably fixed to the connecting cylinder 22 and integrally rotated with the connecting cylinder 22. The left surface of the cap 36 is disposed on the right side (inner side) of the left surface (outer periphery) of the knob 28.

The coupling protrusion 38A of the coupling claw 38 (connecting portion) of the cap 36 is locked around the coupling hole 28C (connected portion) of the knob 28, the knob 28 is integrally rotatably connected to the cap 36, and in a case in which the knob 28 is operated to rotate the front portion upward, the cap 36, the connecting cylinder 22, and the shaft 20 are rotated integrally with the knob 28, and the lock mechanism 18 unlocks the tilting of the seat back 14.

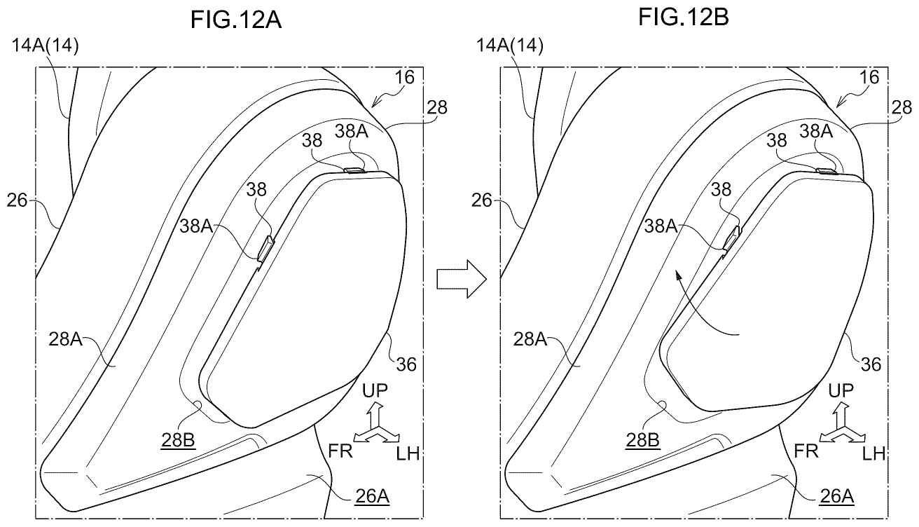

In a case in which an impact load from the B-pillar of the vehicle is input to the knob 28 at the time of side collision of the vehicle and the knob 28 is moved rightward (inward in the vehicle width direction) to release the locking of the coupling claw 38 around the coupling hole 28C, the knob 28 is disconnected from the cap 36 (see a solid line in FIG. 11A and FIG. 12A). Therefore, even in a case in which the knob 28 is operated to rotate by an impact load, the rotation of the cap 36 can be suppressed, so that the unlocking of the tilting of the seat back 14 can be suppressed and the unnecessary tilting of the seat back 14 can be suppressed.

The left surface of the cap 36 is disposed on the right side of the left surface of the knob 28 (see the two-dot chain line of the knob 28 and the solid line of the cap 36 in FIG. 11A). Therefore, at the time of side collision of the vehicle, an impact load can be input to the knob 28 before the cap 36, and the knob 28 can be appropriately disconnected from the cap 36.

After the side collision of the vehicle (after the knob 28 is disconnected from the cap 36), the fixing of the cap 36 to the connecting cylinder 22 is maintained. Therefore, the cap 36 is operated to rotate the front portion upward (see FIG. 12B), the tilting of the seat back 14 can be unlocked, the seat back 14 can be tilted, and the occupant can escape to the outside of the vehicle, for example.

In a case in which the locking protrusion 32A of the locking claw 32 of the knob 28 is locked to the left end portion of the connecting cylinder 22, the leftward movement of the knob 28 is locked and the detachment of the knob 28 from the connecting cylinder 22 is locked (see FIGS. 10A and 11B). Therefore, even in a case in which the locking of the coupling claw 38 to the periphery of the coupling hole 28C is released and the knob 28 is disconnected from the cap 36 at the time of side collision of the vehicle, the locking protrusion 32A of the locking claw 32 is locked to the left end portion of the connecting cylinder 22, so that the detachment of the knob 28 from the connecting cylinder 22 can be restricted.

What is claimed is:

1. A reclining device comprising:
a lock mechanism locking tilting of a seat back in a vehicle seat;
a connecting member connected to the lock mechanism, the connecting member being rotated so that the lock mechanism unlocks tilting of the seat back; and
an operation member connected to the connecting member, the operation member being operated to rotate the connecting member and being disconnected from the connecting member by receiving an impact load at a time of a side collision of a vehicle.

2. The reclining device according to claim 1, wherein the connecting member is disposed inside an outer periphery of the operation member.

3. The reclining device according to claim 1, comprising a locking portion locking detachment of the operation member.

4. The reclining device according to claim 1, wherein the operation member is connected to the connecting member by a biasing force after the operation member has been disconnected from the connecting member.

5. The reclining device according to claim 1, wherein the connecting member is operated to be rotatable after the operation member has been disconnected from the connecting member.

6. The reclining device according to claim 1, comprising a crushed portion crushed so that the operation member is disconnected from the connecting member in a case in which an impact load is input to the operation member at the time of a side collision of the vehicle.

7. The reclining device according to claim 1, wherein connection between the operation member and the connecting member is guided after the operation member has been disconnected from the connecting member.

8. A vehicle seat comprising:
a seat cushion;
a seat back; and
the reclining device according to claim 1 provided between the seat cushion and the seat back.
